(19) United States
(12) Patent Application Publication
(10) Pub. No.: US 2008/0074900 A1
(43) Pub. Date: Mar. 27, 2008

(54) Backlight module

(75) Inventors: Po-Hsiu Sung, Taichung (TW); Po-Hung Lin, Taichung (TW); Kuan-Lun Huang, Taichung (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Jeng Shiang Precision Ind. Co., Ltd., Taichung (TW)

(21) Appl. No.: 11/800,992

(22) Filed: May 8, 2007

(30) Foreign Application Priority Data
Sep. 25, 2006 (TW) 095135347

(51) Int. Cl. F21V 8/00

(52) U.S. Cl. 362/606

(57) ABSTRACT

A backlight module includes: a light source capable of providing light beams; a light guide plate including a plate body that has a light exit side, a base side and a light incident side, and a plurality of quadrilateral pyramidal light-guiding structures distributed on the plate body and capable of changing optical paths of the light beams propagating through the light guide plate such that the light beams exit the plate body with angles relative to a normal of the light exit side that fall within a predefined range; a reflector layer disposed proximate to the base side; and an optical layer disposed proximate to the light exit side, and having a light collecting side that confronts the light exit side, the optical layer being formed with a plurality of prismatic structures at the light collecting side, the prismatic structures extending parallel to the light incident side.

### CROSS-REFERENCE TO RELATED APPLICATION

This application claims priority of Taiwanese Application No. 095135347, filed on Sep. 25, 2006.

### BACKGROUND OF THE INVENTION

1. Field of the Invention

The invention relates to a component of a liquid crystal display, more particularly to a backlight module for a liquid crystal display.

2. Description of the Related Art

As shown in FIG. 1, a conventional side light-type backlight module 10 includes a light guide plate 11 having a light-incident side 111 and a light-exit side 112, a light-emitting diode (LED) light source 12 disposed proximate to the light-incident side 111, a first diffuser plate 13 disposed adjacent to the light-exit side 112 of the light guide plate 11, a reflector plate 14 disposed adjacent to another side of the light guide plate 11 opposite to the light exit side 112, two gain plates 15 disposed adjacent to one side of the first diffuser plate 13 opposite to the light guide plate 11, and a second diffuser plate 16 disposed adjacent to one side of the gain plates 15 opposite to the first diffuser plate 13. The LED light source 12 includes a plurality of aligned light-emitting diodes (LEDs) 121, which are capable of providing light beams that enter into the light guide plate 11 via the light-incident side 111. The light beams are reflected or refracted within the light guide plate 11, where a major portion of the light beams are refracted to exit the light guide plate 11 via the light-exit side 112, and a minor portion of the light beams are directed toward the reflector plate 14 to be further reflected thereby back into the light guide plate 11. The first diffuser plate 13 is capable of diffusing evenly the light beams that exit the light guide plate 11 via the light-exit side 112 and that propagate toward the gain plates 15. Each of the gain plates 15 includes a plurality of prismatic structures 151. In particular, the gain plates 15 include a first gain plate 15′ and a second gain plate 15″, and the prismatic structures 151′ of the first gain plate 15′ are transverse to the prismatic structures 151″ of the second gain plate 15″. When the light beams pass through the gain plates 15, the prismatic structures 151 cause the light beams emerging from the gain plates 15 to be concentrated in a predefined direction toward the second diffuser plate 16. This way, the light beams can be evenly distributed and directed into a liquid crystal panel (not shown).

Although the conventional backlight module 10 described above is capable of providing source light to the liquid crystal panel, the following shortcomings exist during assembly of the conventional backlight module 10 to the liquid crystal panel:

1. Considering the components of the conventional backlight module 10, where a thickness of the LED light source 12 ranges from 0.6 to 0.8 mm, and a combined thickness of the stacked reflector plate 14, light guide plate 11, first diffuser plate 13, gain plates 15 and second diffuser plate 16 ranges from 1.2 to 1.4 mm, the overall thickness of the conventional backlight module 10 is determined by the combined thickness of the stacked plates 11, 13, 14, 15 as opposed to the LED light source 12. With the growing trend of LED light sources to become progressively thinner, the combined thickness of the stacked plates 11, 13, 14, 15 hinders the reduction in the overall thickness of the conventional backlight module 10.

2. An angle between a normal direction of the conventional backlight module 10 and a direction of the light beams emerging from the conventional backlight module 10 is defined to be a light radiating angle. On a plot with the light radiating angle as the x-axis and luminance of the conventional backlight module 10 as the y-axis, it is observed that the luminance varies gradually over varying values of the light radiating angle, and is not concentrated with in a particular range. Consequently, energy of the light beams emerging from the conventional backlight module 10 cannot be utilized efficiently and effectively to achieve a good viewing angle.

### SUMMARY OF THE INVENTION

Therefore, the object of the present invention is to provide a backlight module that has a reduced overall thickness as compared to the prior art, and that is capable of correcting angle of irradiated light beams.

According to the present invention, there is provided a backlight module that includes a light source, a light guide plate, a reflector layer, and an optical layer.

The light source is capable of providing light beams.

The light guide plate includes a plate body and a plurality of light-guiding structures distributed on the plate body. The plate body includes a light exit side, a base side opposite to the light exit side, and a light incident side interconnecting the light exit side and the base side. The light beams provided by the light source enter the light guide plate through the light incident side. Each of the light-guiding structures is in a substantially quadrilateral pyramidal form. The light-guiding structures are capable of changing optical paths of the light beams entering the light guide plate via the light incident side and propagating through the light guide plate such that the light beams exit the light exit side of the plate body with angles relative to a normal of the light exit side that fall within a predefined range.

The reflector layer is disposed proximate to the base side of the plate body of the light guide plate.

The optical layer is disposed proximate to the light exit side of the plate body of the light guide plate, and has a light collecting side that confronts the light exit side, and a light radiating side that is disposed opposite to the light collecting side. The optical layer is formed with a plurality of prismatic structures at the light collecting side. The prismatic structures extend parallel to the light incident side of the plate body of the light guide plate.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional side light-type backlight module;

FIG. 2 is an exploded perspective view of the preferred embodiment of a backlight module according to the present invention;

FIG. 3 is a side schematic view of the preferred embodiment;

FIG. 4 is a fragmentary enlarged schematic view of the preferred embodiment, illustrating optical paths of light beams propagating between a reflector layer, a light guide plate, and an optical layer;

FIG. 5 is a plot illustrating a result of an experiment conducted to measure distribution of luminance at a light exit side of the light guide plate; and

FIG. 6 is a plot illustrating results of an experiment conducted to analyze the distributions of luminance of light beams exiting an optical layer of the preferred embodiment and a gain plate of two comparative examples.

### DETAILED DESCRIPTION OF THE PREFERRED EMBODIMENT

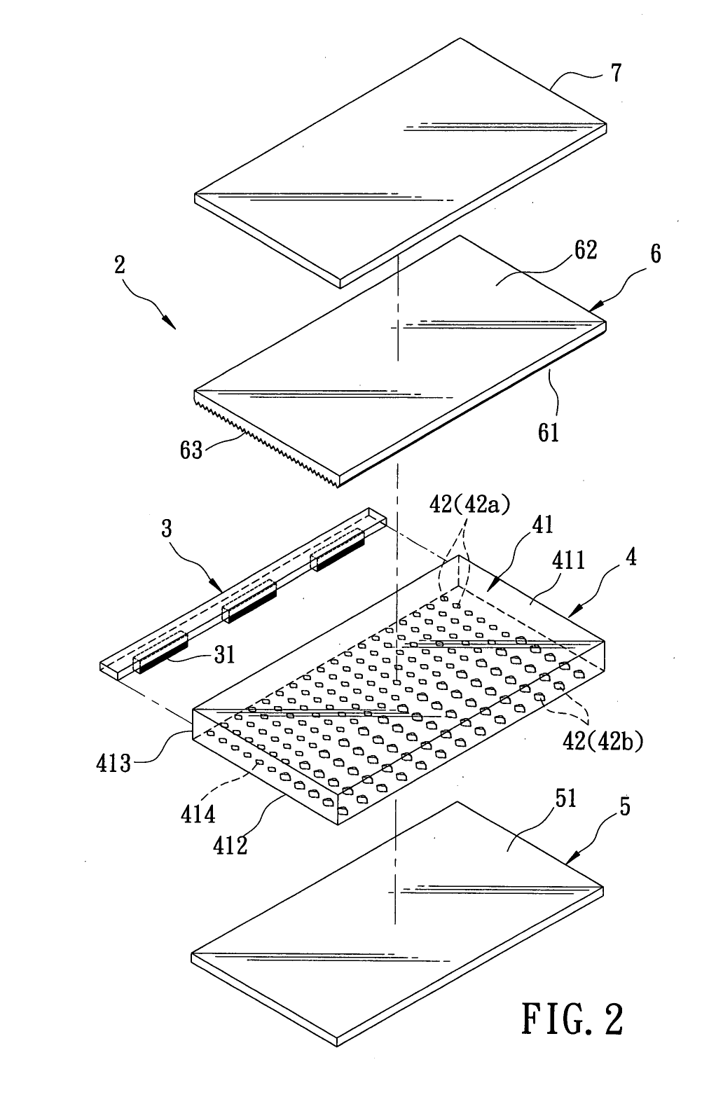

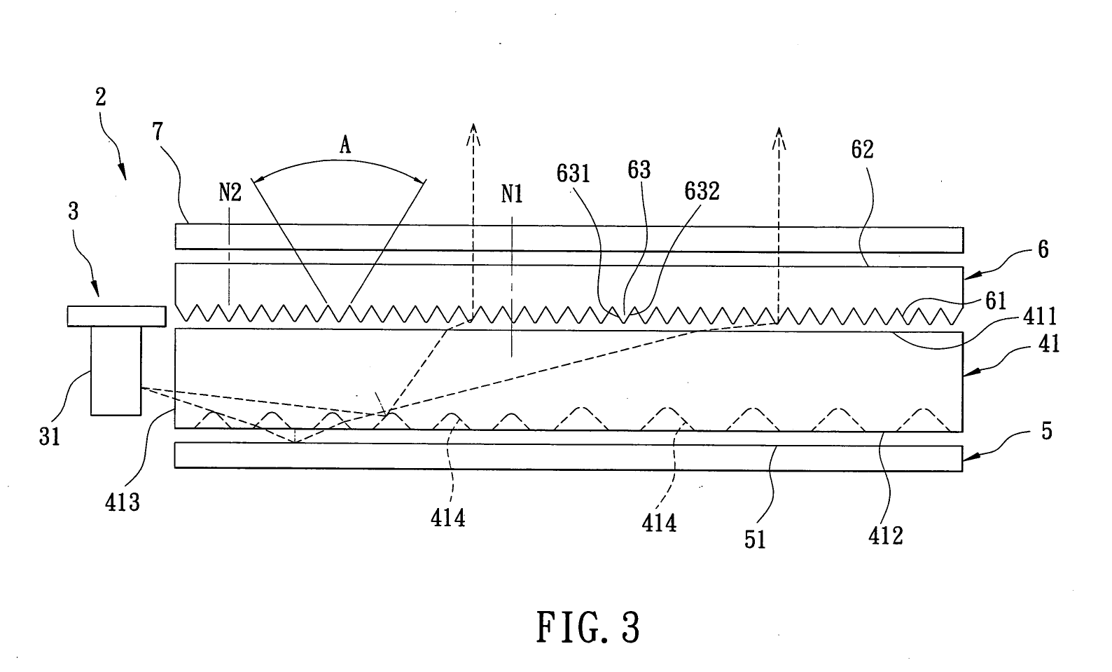

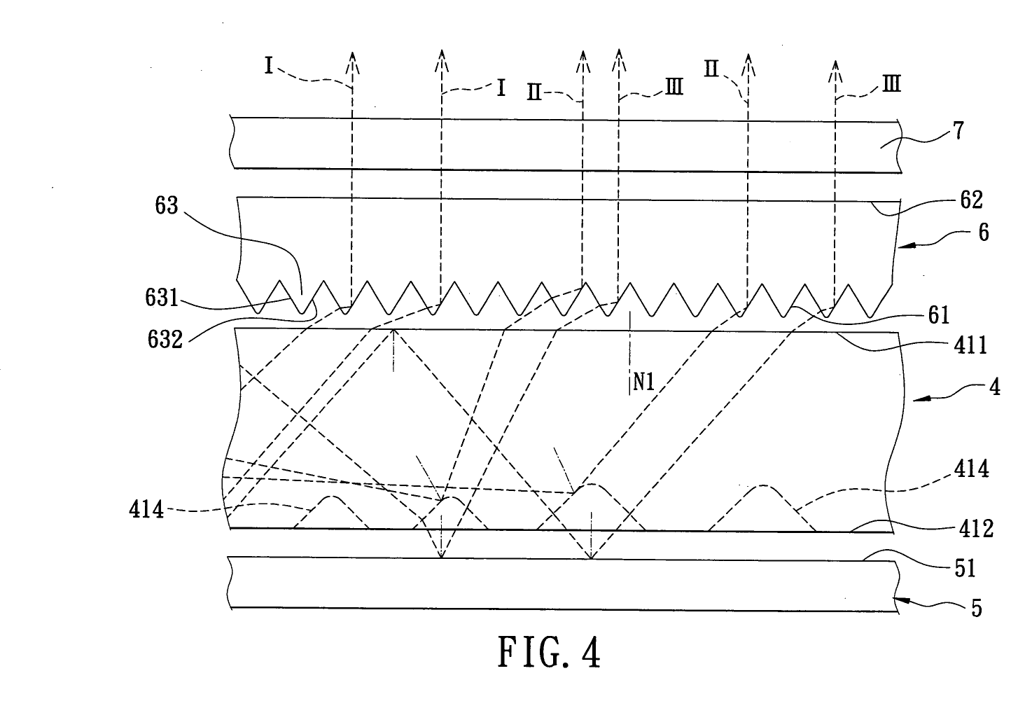

Referring to FIG. 2, FIG. 3 and FIG. 4, the preferred embodiment of a backlight module 2 according to the present invention includes a light source 3, a light guide plate 4, a reflector layer 5, an optical layer 6, and an auxiliary optical layer 7.

The light source 3 includes a plurality of light-emitting diodes (LEDs) 31 that are aligned with each other and that are capable of providing light beams.

In this embodiment, the light guide plate 4 is of the type disclosed in commonly-owned co-pending U.S. patent application Ser. No. 11/784,828, filed on Apr. 9, 2007. In particular, the light guide plate 4 includes a plate body 41 and a plurality of light-guiding structures 42 distributed on the plate body 41. The plate body 41 includes a light exit side 411, a base side 412 opposite to the light exit side 411, and a light incident side 413 interconnecting the light exit side 411 and the base side 412. The light beams provided by the light source 3 enter the light guide plate 4 through the light incident side 413. Each of the light-guiding structures 42 is in a substantially quadrilateral pyramidal form. The light-guiding structures 42 are capable of changing optical paths of the light beams entering the light guide plate 4 via the light incident side 413 and propagating through the light guide plate 4 such that the light beams exit the light exit side 411 of the plate body 41 with angles relative to a normal (N1) of the light exit side 411 that fall within a first predefined range. In this embodiment, the light-guiding structures 42 are distributed in a matrix on the plate body 41, and are equidistantly spaced in the matrix. The light-guiding structures 42 are formed on the base side 412 of the plate body 41. The plate body 41 is formed with a plurality of grooves 414 extending from the base side 412 toward the light incident side 413. Each of the grooves 414 is in a substantially quadrilateral pyramidal form, and serves as a corresponding one of the light-guiding structures 42. Furthermore, the plurality of light-guiding structures 42 include a plurality of small light-guiding structures 42a disposed at parts of the plate body 41 where the amount of the light beams provided by the light source 3 impinging thereupon is large, and a plurality of large light-guiding structures 42b sized larger than the small light-guiding structures 42a, and disposed at parts of the plate body 41 where the amount of the light beams impinging thereupon is small. Consequently, the light beams exiting the light guide plate 4 are uniformly distributed. In this embodiment, the first predefined range is between 55 and 75 degrees.

The size of the light-guiding structures 42 can be as small as 40 μm. However, it should be noted herein that the light-guiding structures 42 are purposely enlarged in relevant drawings for clarity of illustration.

The reflector layer 5 is disposed proximate to the base side 412 of the plate body 41 of the light guide plate 4, and has a reflective side 51.

The optical layer 6 is disposed proximate to the light exit side 411 of the plate body 41 of the light guide plate 4, and has a light collecting side 61 that confronts the light exit side 411, and a light radiating side 62 that is disposed opposite to the light collecting side 61. The optical layer 6 is formed with a plurality of prismatic structures 63 at the light collecting side 61. The prismatic structures 63 extend parallel to the light incident side 413 of the plate body 41 of the light guide plate 4. Each of the prismatic structures 63 has first and second optical surfaces 631, 632 that extend along a direction of the light incident side 413. The first optical surface 631 faces toward the light source 3, while the second optical surface 632 faces away from the light source 3. The first and second optical surfaces 631, 632 cooperate to define an included angle (A) falling within a second predefined range such that the light beams exit the optical layer 6 along a normal (N2) of the light radiating side 62. Furthermore, in this embodiment, the prismatic structures 63 are equidistantly spaced on the light collecting side 61 of the optical layer 6. In this embodiment, the second predefined range of the included angle (A) is between 55 and 65 degrees.

The auxiliary optical layer 7 is disposed proximate to the light radiating side 62 of the optical layer 6, and has at least one of light diffusing and light polarizing properties. In this embodiment, the auxiliary optical layer 7 has light diffusing property such that the light beams exiting the auxiliary optical layer 7, i.e., the light beams exiting the backlight module 2, are uniformly distributed into a liquid crystal panel (not shown). In other embodiments of the present invention, the auxiliary optical layer 7 has light polarizing property such that luminance of the light beams exiting the backlight module 2 is increased.

It should be noted herein that the auxiliary optical layer 7 can be in the form of a plate or particles distributed over the light radiating side 62 of the optical layer 6 so as to form a coating thereon that includes a plurality of particles.

The operating mechanism of the backlight module 2 according to the present invention will now be described in the following paragraphs.

Referring to FIG. 3 and FIG. 4, when the light beams enter the light guide plate 4 via the light incident side 413 of the plate body 41, other than a small portion of the light beams being scattered, a major portion of the light beams exit the light guide plate 4 via the light exit side 411. Prior to exiting the light exit side 411, the light beams can propagate in one of the following optical paths:

1. The light beams exit the light guide plate 4 directly via the light exit side 411 upon being refracted by the light guide plate 4 (as illustrated by optical path (I) in FIG. 4).

2. The light beams impinge the light-guiding structures 42 and are reflected thereby prior to exiting the light guide plate 4 via the light exit side 411 and being refracted at the light exit side 411 (as illustrated by optical path (II) in FIG. 4).

3. The light beams exiting the light guide plate 4 from the base side 412 and impinging the reflector layer 5 are reflected by the reflector layer 5 back into the light guide plate 4, and eventually exit the light guide plate 4 via the light exit side 411 while being refracted at the light exit side 411 (as illustrated by optical path (III) in FIG. 4).

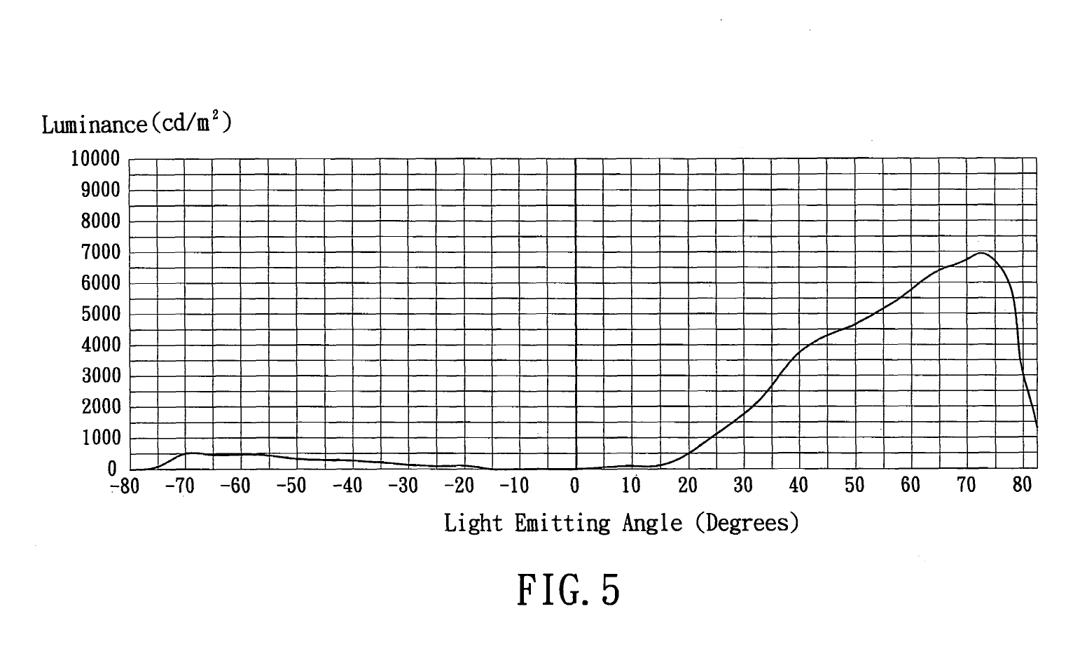

With an angle between the direction of the normal (N1) of the light exit side 411 of the plate body 41 and a path direction of a light beam exiting the light guide plate 4 via the light exit side 411 being defined to be a light emitting angle, an experiment was conducted to measure the distribution of luminance at the light exit side 411 with respect to the light emitting angle. The result is illustrated in FIG. 5 as a curve, where the x-axis represents the light-emitting angle, and the y-axis represents the luminance at the light exit side 411. It can be seen from the result that light-emitting angles are concentrated within a 20-degree range (i.e., between 55 to 75 degrees relative to the normal (N1) of the light exit side 411).

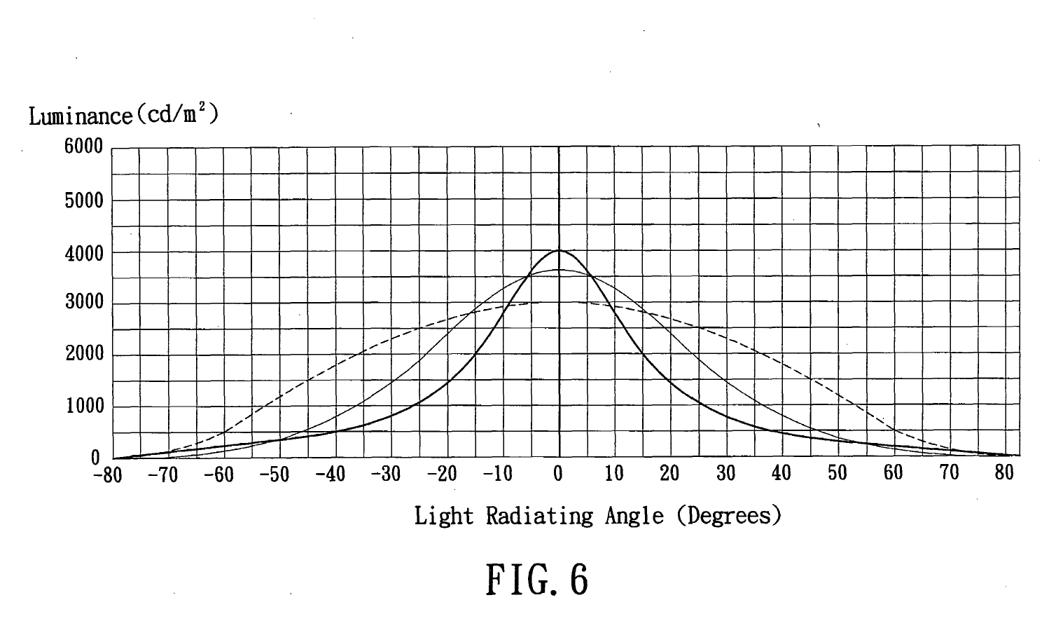

In this embodiment, in order to match the distribution of the light beams at the light exit side 411 (i.e., concentrated between 55 to 75 degrees relative to the normal (N1)), the optical layer 6 disposed proximate to the light exit side 411 is designed such that the included angle (A) defined between the first and second optical surfaces 631, 632 of each of the prismatic structures 63 falls within the second predefined range ranging between 55 and 65 degrees. In this embodiment, the included angle (A) is 62 degrees. Therefore, after propagating along the optical paths (I), (II), (III), the light beams enter the optical layer 6 via the first optical surfaces 631 of the prismatic structures 63, are refracted thereby, and are subsequently reflected by the second optical surfaces 632 toward the light radiating side 62 so as to exit the optical layer 6 along the normal (N2) of the light radiating side 62. An experiment was conducted to analyze the distribution of luminance at the light radiating side 62 with respect to a light radiating angle defined between a direction of the normal (N2) of the light radiating side 62 and a path direction of a light beam exiting the optical layer 6 via the light radiating side 62, the result of which is illustrated in FIG. 6. In FIG. 6, the x-axis represents the light radiating angle, and the y-axis represents the luminance at the light radiating side 62. Two comparative examples were also analyzed with results also shown in FIG. 6. In the first comparative example, a backlight module including a light guide plate formed by etching in the conventional manner, and a gain plate manufactured by 3M company in place of the optical layer 6 of the present invention was used, and the distribution of luminance at the gain plate was analyzed. In the second comparative example, a backlight module including the light guide plate 4 according to the present invention and a gain plate manufactured by 3M company in place of the optical layer 6 of the present invention was used, and the distribution of luminance at the gain plate was analyzed. Three curves are seen in FIG. 6, where a dashed curve represents the distribution of luminance for the first comparative example, a thin solid line represents the distribution of luminance for the second comparative example, and a thick solid line represents the distribution of luminance for the preferred embodiment of a backlight module 2 according to the present invention.

The dashed curve shows that an approximately 3000 cd/m² maximum luminance occurs when the light radiating angle is 0 degrees, and the half-luminance light radiating angles are −45 and +45 degrees with 1500 cd/m² luminance. Therefore, the luminance distribution for the first comparative example is concentrated within a 90-degree range of between −45 and +45 degrees. The thin solid curve shows that an approximately 3600 cd/m² maximum luminance occurs when the light radiating angle is 0 degrees, and the half-luminance light radiating angles are −25 and +25 degrees with 1800 cd/m² luminance. Therefore, the luminance distribution for the second comparative example is concentrated within a 50-degree range of between −25 and +25 degrees. The thick solid curve shows that an approximately 4000 cd/m² maximum luminance occurs when the light radiating angle is 0 degrees, and the half-luminance light radiating angles are −15 and +15 degrees with 2000 cd/m² luminance. Therefore, the luminance distribution for the present invention is concentrated within a 30-degree range of between −15 and +15 degrees. In short, the backlight module 2 according to the present invention not only increases the maximum luminance occurring at a 0-degree light radiating angle from 3000 cd/m² to 4000 cd/m² as compared to the prior art, but the luminance distribution is also more concentrated as compared to the prior art, from a 90-degree range to a 30-degree range.

It should be noted herein that although in this preferred embodiment, a majority of the light beams exit the light exit side 411 of the plate body 41 of the light guide plate 4 with angles falling within the first predefined range of between 55 and 75 degrees relative to the normal (N1) of the light exit side 411, with any slight variation in the first predefined range in other embodiments of the present invention, the second predefined range of between 55 and 65 degrees for the included angle (A) (referring to FIG. 3) defined between the first and second optical surfaces 631, 632 of the prismatic structures 63 of the optical layer 6 may have to be adjusted accordingly such that the light beams exit the optical layer 6 along the normal (N2) of the light radiating side 62.

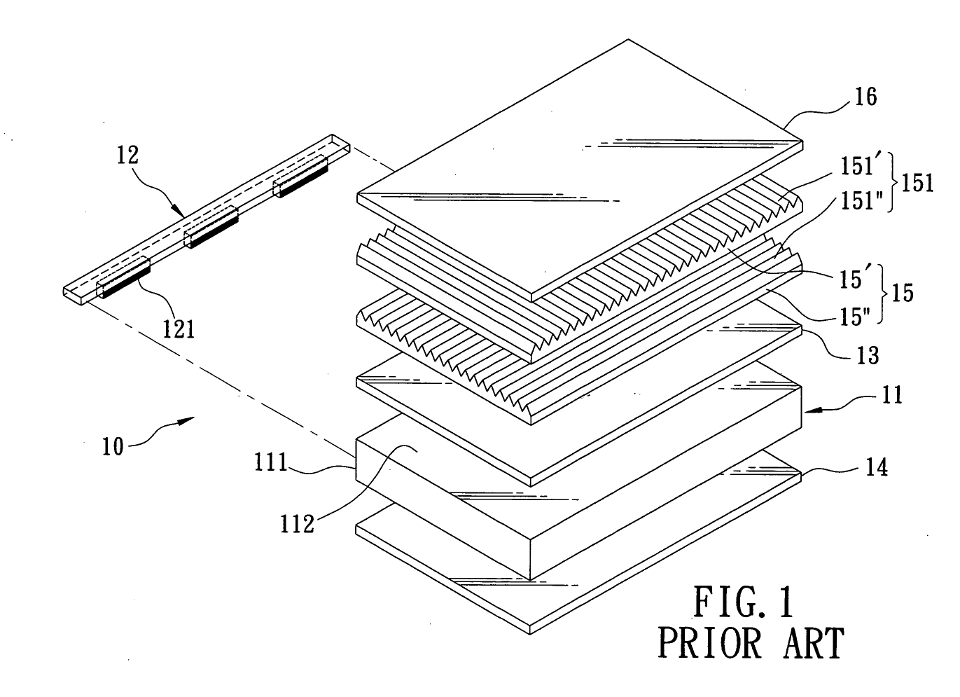

In sum, the backlight module 2 according to the present invention reduces the number of constituting components by utilizing one light guide plate 4 and one optical layer 6 in place of the one diffuser plate 13 (as shown in FIG. 1) and the two gain plates 15 (as shown in FIG. 1) used in the prior art such that the total thickness of the backlight module 2 having the reflector layer 5, the light guide plate 4, the optical layer 6 and the auxiliary optical layer 7 stacked together is effectively decreased to 1.0 to 1.1 mm.

In addition, the first predefined range of between 55 and 75 degrees for the light beams exiting the light exit side 411 of the plate body 41 of the light guide plate 4 relative to the normal (N1) of the light exit side 411 cooperates with the second predefined range of between 55 and 65 degrees for the included angle (A) (referring to FIG. 3) defined between the first and second optical surfaces 631, 632 of the prismatic structures 63 of the optical layer 6 to increase the luminance of the light beams exiting the backlight module 2 via the light radiating side 62 of the optical layer 6, and to concentrate the luminance distribution to within a 30-degree range relative to the normal (N2) of the light radiating side 62 (i.e., between −15 to +15 degrees with the normal (N2) denoted by 0 degrees). Consequently, energy of the light beams emerging from the backlight module 2 according to the present invention is efficiently utilized to achieve a good viewing angle.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A backlight module comprising:
a light source capable of providing light beams;
a light guide plate including a plate body and a plurality of light-guiding structures distributed on said plate body, said plate body including a light exit side, a base side opposite to said light exit side, and a light incident side interconnecting said light exit side and said base side, the light beams provided by said light source entering said light guide plate through said light incident side, each of said light-guiding structures being in a substantially quadrilateral pyramidal form, said light-guiding structures being capable of changing optical paths of the light beams entering said light guide plate via said light incident side and propagating through said light guide plate such that the light beams exit said light exit side of said plate body with angles relative to a normal of said light exit side that fall within a first predefined range;
a reflector layer disposed proximate to said base side of said plate body of said light guide plate; and
an optical layer disposed proximate to said light exit side of said plate body of said light guide plate, and having a light collecting side that confronts said light exit side, and a light radiating side that is disposed opposite to said light collecting side, said optical layer being formed with a plurality of prismatic structures at said light collecting side, said prismatic structures extending parallel to said light incident side of said plate body of said light guide plate.

2. The backlight module as claimed in claim 1, wherein each of said prismatic structures has first and second optical surfaces that extend along direction of said light incident side, and that cooperate to define an included angle falling within a second predefined range such that the light beams exit said optical layer along a normal of said light radiating side.

3. The backlight module as claimed in claim 2, wherein said first predefined range is between 55 and 75 degrees.

4. The backlight module as claimed in claim 3, wherein said second predefined range of said included angle is between 55 and 65 degrees.

5. The backlight module as claimed in claim 4, wherein said included angle is 62 degrees.

6. The backlight module as claimed in claim 1, wherein said prismatic structures are equidistantly spaced on said light collecting side of said optical layer.

7. The backlight module as claimed in claim 1, wherein said light radiating side of said optical layer is provided with a diffusive coating layer that includes a plurality of diffusing particles.

8. The backlight module as claimed in claim 1, further comprising an auxiliary optical layer disposed proximate to said light radiating side of said optical layer, and having at least one of light diffusing and light polarizing properties.

9. The backlight module as claimed in claim 1, wherein said light-guiding structures are formed on said base side of said plate body.

10. The backlight module as claimed in claim 9, wherein said plate body is formed with a plurality of grooves extending from said base side toward said light incident side, each of said grooves being in a substantially quadrilateral pyramidal form, and serving as a corresponding one of said light-guiding structures.
